(19) United States
(12) Patent Application Publication
(10) Pub. No.: US 2002/0095307 A1
(43) Pub. Date: Jul. 18, 2002

(54) System and method for inventory and capacity availability management

(75) Inventors: Christopher A. Greamo, Washington, DC (US); Michael L. Hooks, Germantown, MD (US); David Weber, Olney, MD (US); Robert Mitchell, North Potomac, MD (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc., Rockville, MD

(21) Appl. No.: 09/984,346

(22) Filed: Oct. 29, 2001

Related U.S. Application Data
(60) Provisional application No. 60/243,400, filed on Oct. 27, 2000.

(51) Int. Cl. G06F 17/60

(52) U.S. Cl. 705/1

(57) ABSTRACT

The present invention provides a system and method whereby a user having the proper permissions to access a supply chain may check the availability of an item within the supply chain network. There are three different types of availability that can be checked: (1) current inventory availability, (2) available to promise inventory (projected+current inventory), and (3) capable to promise inventory (current inventory+projected inventory+capacity for manufacturing, labor, materials, and transportation). Preferably, the system is accessible over a distributed network such as the Internet, thereby facilitating remote access by allowing remote customers to receive a reliable commitment of delivery. The system further allows businesses to offer improved customer support in multiple commercial channels.

### RELATED APPLICATIONS

This application claims priority from U.S. Provisional Application Serial No. 60/243,400, filed Oct. 27, 2000, the disclosure of which is hereby incorporated by reference in its entirety.

### FIELD OF THE INVENTION

Disclosed is a system and method for inventory and capacity availability management. In particular, the present invention pertains to a system and method for managing inventory so as to coordinate the providing of desired goods, or suitable alternatives therefore, in response to an order from a customer.

### BACKGROUND OF THE INVENTION

Companies may win or lose business based on the ability to quickly and accurately confirm product availability, including delivery and configuration, to customers. Companies making such commitments consider multiple factors such as profitability, current and projected inventory positions, manufacturing and transportation capabilities, appropriate substitution and configuration alternatives, and relative priority and urgency of this commitment versus existing commitments. Companies making these commitments using various modes of communication, such as the Internet, phone, on-site account teams, or continuous fulfillment, may gain a significant advantage in customer service.

A major challenge for business is ensuring the on-time delivery of an order. Businesses generally do not have the ability to immediately respond to a customer's order because the business cannot simultaneously check configuration, substitution, and delivery alternatives.

At the same time, businesses would optimally want to be proactive with customer service commitments by offering alternative products or options based on availability. Even if the business is capable of identifying the unavailability of products, the businesses typically do not have the ability to suggest substitute products. In particular, a customer may prefer the on-time delivery of a substitute product rather than the delayed production of a requested product. For instance, the substitute product may be a different size or a comparable product marketed under a different brand.

It is therefore a goal of the present invention to provide accurate, reliable, real-time promises and commitments to customer requests by simultaneously performing availability checks of inventory, production, materials, manufacturing scheduling, distribution, and transportation, then immediately allocating appropriate resources. If a request cannot be satisfied, an improved system should automatically evaluate substitution and configuration alternatives based upon pre-set rules. Through user-defined prioritization, an improved system should further enable preemption, as necessary, to ensure that critical resources are devoted to the user's highest priority customers. The preferred system should also provide capable-to-deliver capabilities to ensure physical transportation is available within an adequate lead-time need to make a customer commitment.

An improved ordering management system should also provide up-to-the-minute information on inventory availability, manufacturing plans, and material availability. Also, because preemption in the manufacturing schedule must be considered when a customer request cannot be satisfied based upon current or projected plans, the preferred system should analyze potential scheduling changes that could satisfy the customer request.

### SUMMARY OF THE PRESENT INVENTION

The system and method of the present invention helps companies cope with common business problems such as special orders. The present invention allows a company to immediately respond to that customer's order because the system and method provides the ability to simultaneously check configuration, substitution, and delivery alternatives, to confirm the product's delivery, and to be proactive with the user's customer service commitments by offering alternative products or options based on availability.

Similarly, businesses often have many disparate trading partners and systems—each with shipment, order, and item-level information that are critical to the effective management of its operations. The system and method of the present invention allows a company to locate the position of all inventory—both discrete and aggregate—from a central location, regardless of their position within the user's trading network. Customer service representatives employing embodiments of the present invention have the ability to find orders and provide proactive status updates via the Internet or email.

The present invention helps provide accurate, reliable, real-time promises and commitments to customer requests by simultaneously performing availability checks of inventory, production, materials, manufacturing scheduling, distribution, and transportation and then immediately allocating appropriate resources as needed to fulfill an order. If a request cannot be satisfied, the present invention automatically evaluates substitution and configuration alternatives based upon user-defined or pre-set default rules.

Through user-defined prioritization of existing customer commitments, the present invention may also preempt certain commitments as necessary to ensure that critical resources are devoted to the user's highest priority customers. The present invention also utilizes capable-to-deliver capabilities to ensure physical transportation is available within the lead-time prior to making a customer commitment.

The present invention provides a system and method whereby a user (having the proper permissions for access) can check the availability of an item (or a product number or SKU) within an entire supply chain network. There are three different types of availability that can be checked: (1) current inventory availability, (2) available to promise inventory (projected+current inventory), and (3) capable to promise inventory (current inventory+projected inventory+capacity for manufacturing, labor, materials, and transportation).

In use, a user (such as an account manager or a customer relationship manager) can determine whether it would be possible to run a product promotion for an account without changing current business obligations (i.e., defaulting on other delivery agreements). In order to ensure that a promotion does not interfere with the current business plan (shipping commitments, current orders, etc.), the user uses the availability system to query what inventory is available for the items involved in the promotion. In order to make such queries in embodiments of the present invention, the user specifies what type of promotion he wishes to perform by entering a combination of the following information: (1) the product or item, (2) location (optional, used if querying for a particular SKU), (3) begin date (optional, only used if checking inventory available to promise or capable to promise), (4) duration, given in days (optional, only used if checking available to promise or capable to promise), and (5) bucket (e.g., daily, weekly, or monthly).

Preferably, the system is accessible over a distributed network such as the Internet. This functionality facilitates remote access by allowing remote customers to receive a reliable commitment of delivery. The system further allows businesses to offer improved customer support in multiple commercial channels.

The use of the present invention helps boost customer loyalty, improve trading partner relationships, and grow revenues by providing customer and channel allocation to help companies meet the needs of its most important trading partners. Allocation rules can be established at all levels of the planning process by committing resources to the user's highest priority customers and channels to ensure those resources are available when needed.

Once allocations are committed, consumption against them can be tracked at all levels in the supply chain, thus providing the necessary visibility to proactively manage an intricate trading network. The present invention satisfies the need for global, item-level visibility of the inventory resources throughout an entire supply chain so as to identify and provide for inventory constraints and reduce failures to deliver on time. Companies in various industries, such as retail, high-tech, consumer packaged goods, etc., need a single source for viewing the status of the user's entire trading network. This includes shipment, order, and/or item-level information. The ability to view the progress and history of items and orders in the user's trading network increases the user's ability to make dynamic sourcing and delivery decisions, increase or decrease order quantities or safety stock levels, and redirect critical inventory, whether in-house or in-route. These capabilities drive significant improvements in customer service, which in turn create a wealth of increased revenue opportunities for the user's organization.

Overall, this improved system would help boost customer loyalty, improve trading partner relationships, and grow revenues by providing customer and channel allocation to help the user meet the needs of the user's most important customers. Allocation rules can be established at all levels of the planning process by committing resources to the user's highest priority customers and channels to ensure those resources are available when needed. Once allocations are committed, consumption against them can be tracked at all levels in the supply chain, providing the visibility the user needs to proactively manage the user's trading network.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIGS 1A-1B illustrate block diagrams of a system to facilitate inventory and capacity availability management in accordance with embodiments of the present invention; and

FIGS. 2A-2B illustrate flow charts depicting steps in a related method to facilitate inventory and capacity availability management in accordance with embodiments of the present invention.

### DETAILED DISCLOSURE OF THE PREFERRED EMBODIMENT

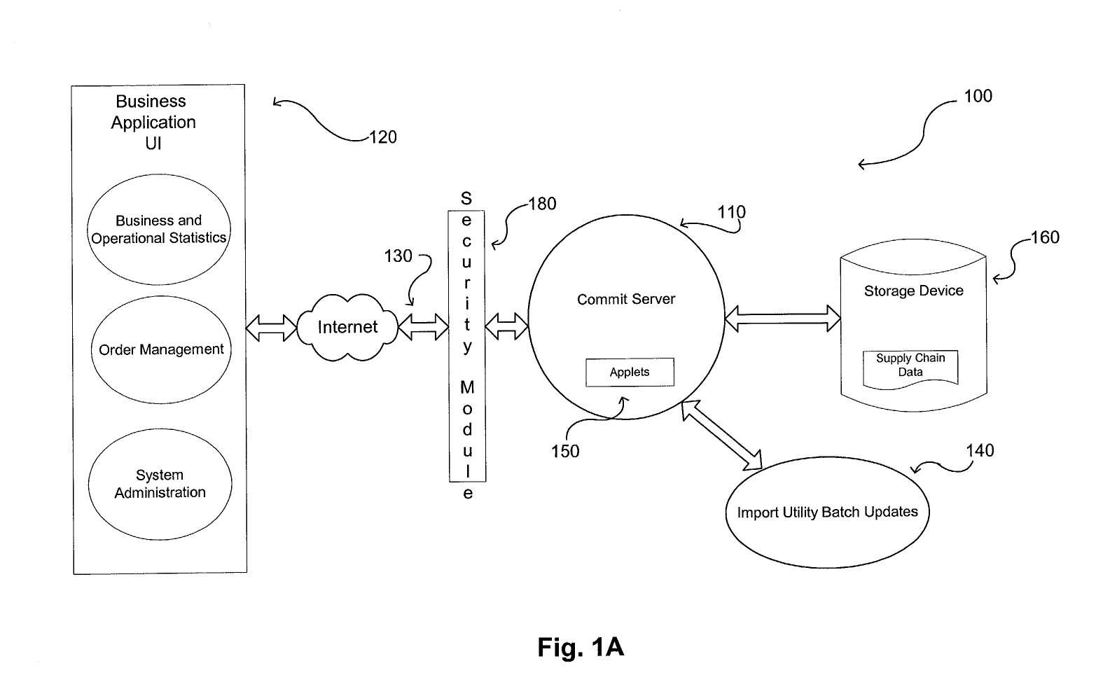

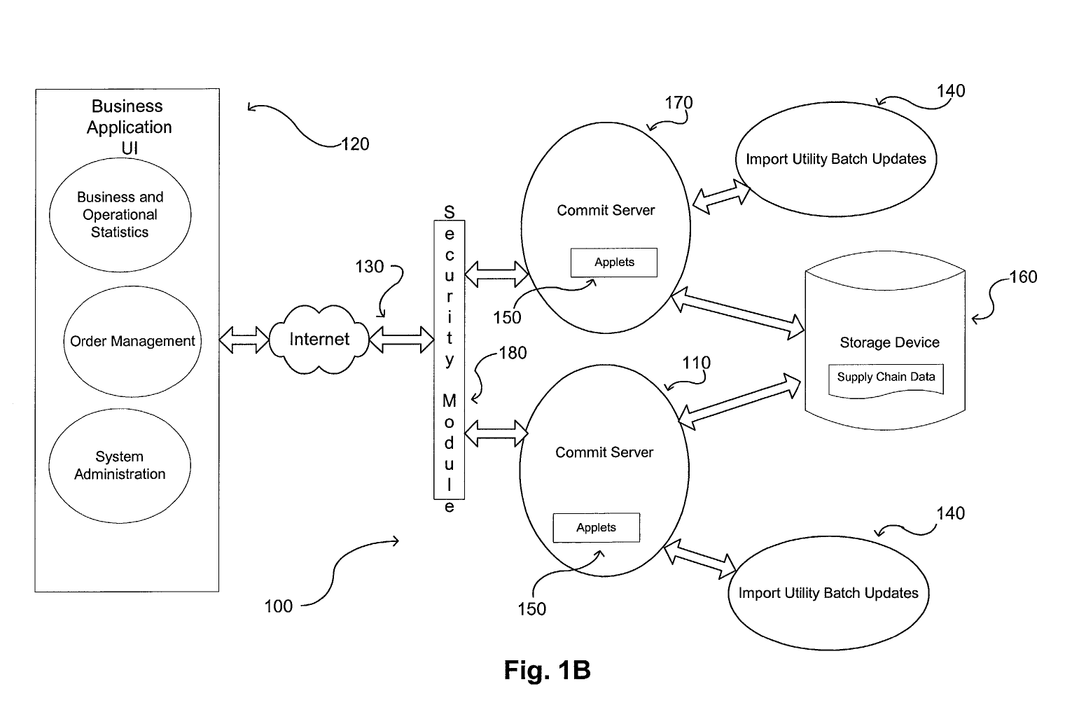

As illustrated in FIGS. 1A-B, the present invention provides a commit system 100 that provides a real-time solution for promising and committing to customer requests. Unlike typical available-to-promise (ATP) solutions, which assume that manufactured product can be delivered as requested, commit system 100 considers the actual constraints of the entire enterprise. When an order is generated, commit system 100 checks the availability of all related inventory and resources in real time. Factors considered include alternate distribution centers, planned production, capable production, alternate sourcing and plants, and alternate raw material suppliers. The commit system 100 only suggests a promise date after evaluating these factors.

Given a need date, the commit system 100 searches whether there is inventory at any given place to meet the order. If inventory is not readily available, then the commit system 100 considers all lead times and capacities to determine when the order can be available to the customer. In this search it looks at:

1. existing inventories of raw materials, components, work in progress and finished goods;

2. projected production plan and purchases of various materials;

3. lead times for raw materials, moving within locations, manufacturing lead times, transportation lead times, etc.; and

4. available spare capacity in the resources. Because of the design of the commit system 100, it can access multiple ordering channels (web, order management system, telephone sales, etc.) so that the entire enterprise is running off the same information. The operation of the commit system 100 is described in greater detail below.

Returning to FIGS. 1A-B, the commit system 100 particularly consists of these components: a commit server 110, a network or Web-based business-to-business (B2B) user interface 120, public APIs 130, a batch import 140, a statistics applet 150, a database 160, and a switchover server 170.

The commit server 110 manages the operations of the commit system 100 and its various components. In one embodiment, the commit server 110 uses a WebLogic™ application server produced by BEA Systems, Inc of San Jose, Calif.

Returning to FIGS. 1A-B, the web-enabled user interface (UI) 120 in the commit system 100 generally handles order management tasks, including checking item availability; adding, editing, and deleting orders; tracking order status; viewing server statistics; and performing system administration tasks. The commit UI 120 typically is based on a business-to-business (B2B) model.

The commit system 100 also includes a one or more public external application program interfaces (APIs) 130 for handling order entry and order commitment, and managing data stored in the database 160. The commit system 100 may further includes a batch import application 140 that can send multiple order requests through the API. The input file is generally XML application used to seek, collect, and control needed information for use in the supply system.

Returning to FIGS. 1A-B, the commit system 100 further includes a statistics applet 150 that collects two kinds of data from a running server: operational statistics and business statistics. The commit server 110 tracks statistics as it processes order transactions and displays this information on the operational statistics page. It also tracks statistics by order status and displays this information on a business statistics page.

The commit database 160, illustrated in FIGS. 1A-B, stores a record of the user's supply chain formed. Specifically, the database typically stores a record of locations in the supply chain, items in the supply chain, the items at each location (stock keeping unit or SKUs), the inventory number of each SKU, processes effecting each SKU (such as sales or replenishments), transportation lanes between the location, costs required to store each SKU, and costs to move each SKU in a transportation lane. Some or all of the information in the database 160 may be subsequently loaded and stored in high speed, volatile memory in the commit server 110. In this way, the commit system may rapidly access and modify the supply chain data. The commit system then intermittently transmits any modification to the supply change data back to the storage device 160 so that the permanently stored record of supply chain data reflects new orders.

As the commit server 110 intermittently transmits the supply chain data to and from the data storage device 160, there may be a momentary delay during which the commit system 100 cannot process new orders. A key requirement is the ability of the commit system 100 to become aware of new supply chain data without having to be shutdown and restarted. To become aware of a new plan the commit server 110 is typically shutdown and then restarted with the new supply chain data. During startup/restart, the supply chain reference data and dynamic data is read from the relational database 160 and transformed into active memory objects. Then, the database 160 is queried for any orders that have been promised or canceled since the last run. Commit system 100 re-promises any of the promised (not yet scheduled) orders and it increments its in-memory capacity for any orders that were canceled. In this way, the commit system 100 becomes aware of the new plan while not losing track of any previously commitment orders.

Because many users wish to have the ability to respond to requests for promises twenty-four hours a day, seven days a week, another embodiment of the commit system 100 illustrated in FIG. 1B continuously processes order commitment requests around the clock. Switchover allows the commit system 100 to continue to make order commitments which the system 100 loads up-to-date supply chain planning information. During switchover, the live server 110 continues to promise against the old, in-memory supply chain containing the old planning information, while a second server 170 (or software application in a multi-tasking environment) is initiated. The second server 170 creates a new in-memory model from the database 160. Any orders that are in a promised state—that is, not yet scheduled—are repromised by the new server against the new in-memory model. During the final stage of switchover, the existing live commit server 110 is suspended. Session beans automatically switch to the new server, and the new server 170 then becomes the live server.

As a result of the system configuration illustrated in FIG. 1B, the commit system 100 continues to process incoming requests during the switchover, so that there is no downtime. The goal is for the switchover to complete with minimal degradation of performance. Another key feature is that the commit system 100 cannot lose track of commitments should it terminate due to manual shutdown or unexpected failure.

Switchover provides a means for the commit system 100 to load a new master plan and transition to it while continuing to process orders. First, a new supply chain data is produced. Commit system 100 then initiates switchover. The new switchover commit server 170 is launched while the current live commit server 110 continues to process transactions. The new switchover commit server 170 reads the reference and dynamic data out of the database and transforms the data into an in-memory object model. The new commit server 170 also processes existing orders by re-promising previously, not yet scheduled promised orders, and by adjusting capacities for both promises and cancellations. Following the transfer of data back to the database 160 and initiation of the switchover server 170, the live server 110 may be suspended at this point. The new switchover commit server 170 reconciles the previous work done by the live server 110 during the time that the customer orders were being processed. The new switchover server 170 becomes the live server and the previous live commit server 110 shuts down until needed for the next plan.

In another implementation of the commit system 100 of FIGS. 1A-1B, a Java applet in the user interface 120 may display the current status of the commit system 100 and orders taken therein. For instance, the status will simply be an indication of whether the system is running or not. The applet displays the output to, inter alia, a web browser.

As illustrated in FIGS. 1A-B, the commit system 100 may also use a common security administration application 180 that controls the users who can access the product, the functions they can access within the product, and the customer order data they can work with. The operation of the security system 180 is described below in step 290.

The security module 180 is used to determine who is able to use the product and which aspects of the commit system 100 each category of user may access. With the security module 180, the user may have differing levels of rights to assess and modify the supply chain. For instance, a user belonging to a certain customer partition may have access only to orders belonging to that partition, and a user associated with a particular Customer may access only orders belonging to that Customer. For instance, a user may be allowed to initiate an inquiry or promise order for the Customer that she represents but not be allowed to create or delete another user for that Customer or to modify the Customer's existing orders and basic information. Different categories of users having different permissions may be defined as needed.

One of the big benefits of the system is improved customer service. If a business has an accurate picture of the supply chain while committing to the order, the business is better able to quote more realistic and achievable due dates. Thus, the business should be able to achieve a competitive advantage since it will be able to deliver reliability to the customers when promised.

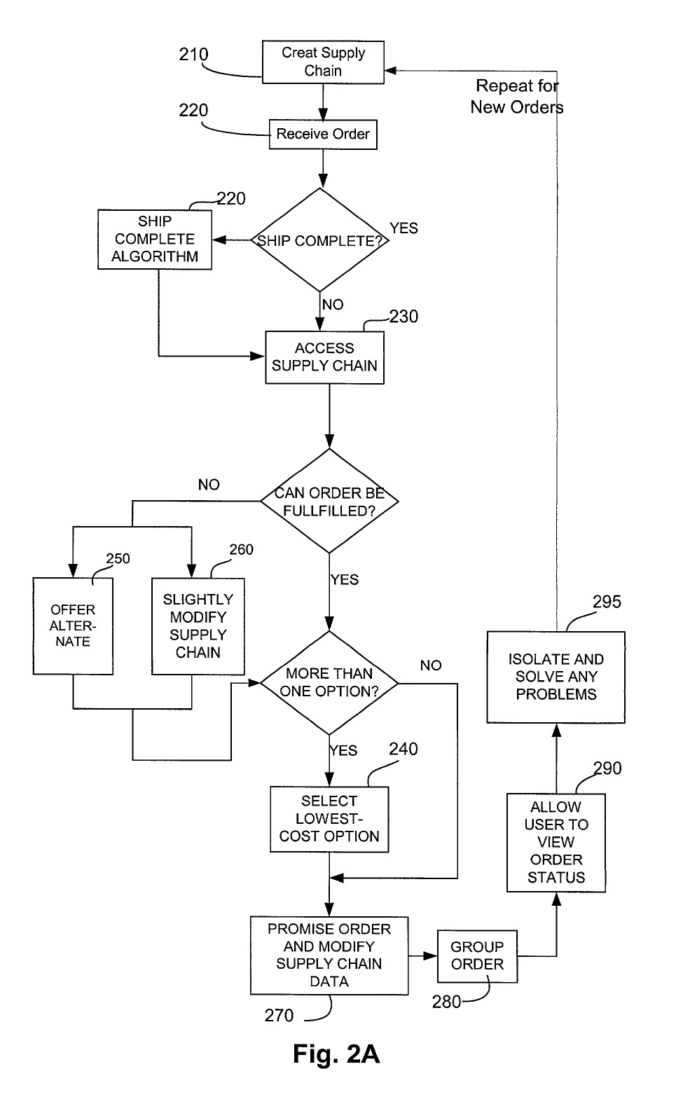

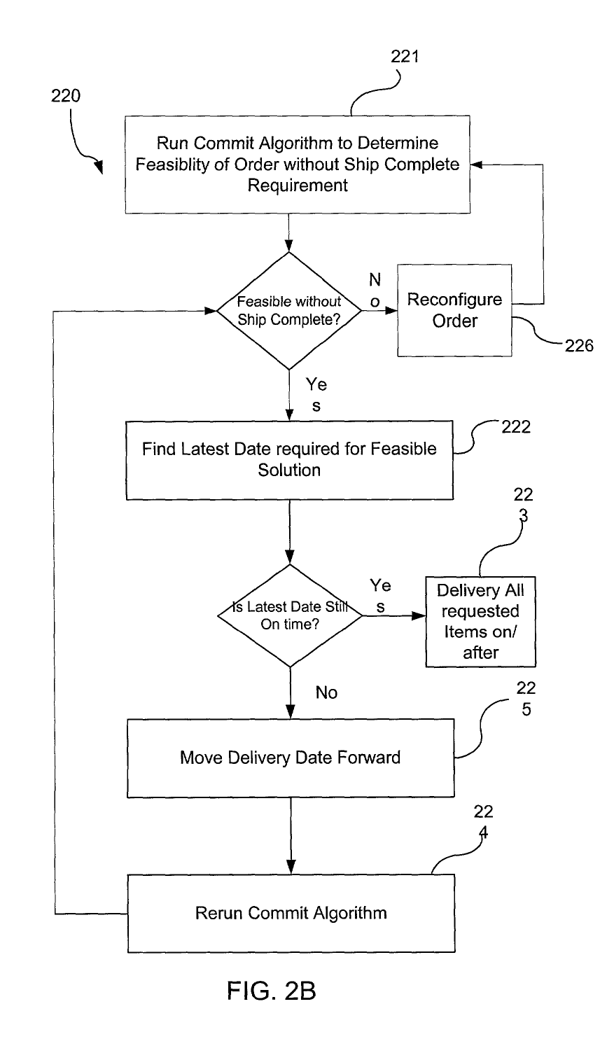

As illustrated in FIG. 2A, the commit system 100 uses an order commitment method 200. First the commit system 100 forms or accesses a supply chain, step 210. Second the commit system 100 receives a new order, step 220. Third the commit system 100 assesses the feasibility of orders, step 230. Fourth, where there is more than one option to fulfill the order, the commit system 100 may checks availability of desired inventory to offer a low-cost solution to meet the order requirements (does not disrupt other orders) update supply chain, step 240. Optionally, the commit system attempts to either slightly modify the implementation of existing orders or to modify the requirements of the current order at issue, steps 250 and 260. Finally, the commit supply 100 may then repeat steps 210-240 with future orders, using supply chain data adjusted in step 270.

In step 210, the commit system 100 forms a supply chain model using known techniques. For instance, a supply chain may be modeled using the techniques described in U.S. Application entitled SYSTEM AND METHOD FOR OPTIMIZING RESOURCE PLANS, filed by Shekar et al., (Attorney Docket No. 82001-0198), the disclosure of which is hereby incorporated by reference in full.

In one embodiment, the commit system 100 has a capable-to-deliver feature to allow customers to specify delivery addresses or transportation zones. Likewise, the commit system 100 may allow users to designate either a specific date or a range of dates within a delivery window as acceptable or not acceptable for receiving deliveries. Thereby, the order may specify combinations of either range of dates and delivery locations or specific particular dates and delivery locations

In a preferred embodiment, in order to realistically promise delivery dates to customers, the commit system 100 further specifies the days on which customers can accept shipments. Therefore, prior to inquiring on an order, the customer may optionally specify what days are acceptable to receive the order. This can be achieved by tying a customer profile to an order or by setting the acceptable delivery dates at the time the order is placed. This information would be tied to the order line item and/or the order header to ensure that the commit system 100 does not contradict the promised delivery. Then, the commit system 100 forms needed shipping dates by offsetting the delivery date by any appropriate transportation and inventory lead-times to the customer.

Returning to FIG. 2A, the commit system 100 receives an order in step 220 using known systems and/or techniques. Typically, the user is a service representative receiving an order from a customer electronically, in person, or over the telephone. The user will then manually enter the order into the commit system 100. Alternatively, the user may be a customer placing an order via the Internet on a website. The commit system 100 may also receive orders via a distributed network as described above in FIGS. 1A-B.

Upon receiving a new order in Step 220, the commit system 100 accesses the supply chain data to determine if the new order may be satisfied given the existing conditions of the supply chain, step 230. The supply chain data can be accessed from the database 160. In step 230, the processing is limited. For instance, the processing may have a limited number of computations or a limited processing time.

After receiving the supply chain data, the commit algorithm next assesses the data as needed to promise line items. A line item is a quantity of an Item or SKU requested for a given date. The algorithm has two major steps of first finding alternatives, and evaluating alternatives/make promises. For an ordered item, the commit system 100 determines all the stock keeping units (SKUs) for that Item. SKU's are a code used to identify a particular item/type of items at a particular location. Then, for each SKU, the system 100 creates a “root” alternative that represents the existing inventory for the SKU. Thus, the preference is to use the items that may be precluded with peaking additional actions. The system next expands the root alternatives by expanding all the supply methods for the SKUs. Each supply method has an optional Route and Supplying SKUs and when expanding an alternative, the routes for the supplied SKUs may be analyzed as well.

The commit system 100 preferably processes orders to a customer in real time during step 230. The customer placing their order is expecting immediate feedback, such as if the order can get met, when the order can get met, and if they should place their order. If the order cannot get met, the customer may want to understand the major roadblock or critical issue related to why their order cannot get met on time, or at all. The real time answer is available because of the limited number of calculations in step 230.

If not presently feasible, the commit system 100 may determine a low-cost method to adjust the supply chain to meet the order in step 260. Likewise, where there are several possible courses of action that allow the user's business to meet the order, the commit system 100 may evaluate the relative costs for each course of action and selecting the least-cost course as part of step 240. Similarly, if a customer desires delivery from a range of items, the commit system 100 determines a cost-effective mix of products to send to the client.

Generally, as a component is expanded the chain of supply methods between the finished good SKU and the current component is saved. All of the alternatives are then evaluated, possibly multiple times, until the line item is filled or there is no supply available. Typically the system 100 evaluates all the different locations to determine when they could supply this line item (earlier than the request date) and how much they could supply. The system 100 chooses the alternative closest to the requested date and makes a possible promise for this alternative. The search for alternatives repeats until the order is met or there is no supply earlier for any of the alternatives, the system 100 then looks later than the requested date.

The commit system 100 generally returns one of the following results:

1) the ordered items are available and may be delivery on time—thus, the total quantity of the order will be met and the customer will receive it on or before the requested date;

2) the ordered items are available Promised and but may be delivered late—the total quantity of the order will be met and the customer will receive it on the date specified that falls after the requested date;

3) the ordered items are partially available and may be delivery on time—the order will be partially met on the date specified; and

4) unmet—the order cannot be met.

Once a course of action is selected, the commit system 100 then adjusts the supply chain so that this order may be taken into consideration when considering future orders, Step 270. The records in the database 160 may be updated periodically to store the new orders. The user may then use the suggested course of action to meet the order deadlines in a low-cost manner.

To revise or cancel an order, the commit system 100 uses an analogous method by which the SKUs from the order are freed for reallocation. The system 100 reiteratively tries different alternatives to determine which is desirable. In this case, the root condition is the present, committed condition minus the cancelled/modified order. To modify the order, the system 100 treats the modified order as a new order. Namely, the system 100 tries first to fill the order using existing, available inventors and then reallocates or orders SKUs as needed to fulfill the order by the due date.

The system 100 then recursively expands the alternative supply methods by expanding each expandable component in the alternative one at a time. A component is expandable if it has supply methods. Each new alternative includes all the Route components from previous alternative. The routes are copied from the previous alternative because it is assumed that each expansion results in the execution of the expanded supply method (i.e. the sub-components must be manufactured or transported to satisfy the line item via this alternative).

Normally, the commit system 100 can come up with different dates for different line items of the order. What ship complete does is give one ship date for all the orders. If all the line items are on or before the need date, then the available date is the due date. If any line item is late, then it will recalculate the delivery dates for all the other orders so that supply in the earlier period is available for orders that might come in early.

To improve customer service, customers may specify an order as “ship complete.” Having an order that is denoted as ship complete means that the customer requests to receive all of the ship complete items together as one shipment. Although improvements in customer service can be ascertained, the use of ship complete does have related costs. For example, because commit system 100 will reserve inventory for the ship complete order, there will be inventory carrying costs associated with the delay of lower priority orders that could have been met in the meantime. Therefore, there is a tradeoff between the benefits derived from increases in customer service and the costs assumed from carrying excess inventory that need to be considered when using the ship complete feature.

Commit system 100 users may generally assign ship complete logic at two levels, either the order header or order line. In the order header, the entire order can be specified as ship complete. This means that the entire order will be held until all line items on the order can be fulfilled. Alternatively, if in the order line, individual line items can be specified as “ship complete.” This means that some line items can be specified as “ship complete” while others can be shipped as partial shipments.

The ship-complete component allows commit system 100 users to specify that all parts of an order should be delivered at the same time (in effect, on the same date). Users may also designate individual line items within a order as ship-complete; this means that all pieces of the line item will be delivered at the same time.

A first step in the general approach for a ship-complete order in step 220 is to run the request through the basic commit algorithm step 221 (steps 210-240) to determine whether the order is feasible without the ship complete option. Secondly, the commit system 100 finds the latest delivery date for all line-items in the order for the ship-complete line item step 222. If this maximum delivery date is on-time and not late, changes each line-item promise date to the maximum delivery date less the lead time and then proceed to promise the complete delivery of the order, step 223. Alternatively, if one or more line-item promise dates are late, the commit system 100 changes all the requested dates to the maximum delivery date, releases all resource commitments made by the promising algorithm, and runs the order through the algorithm a second time. The commit system 100 then moves the delivery date forward if necessary so that the corresponding ship-date at each location is within an open period in the location's effective source calendar.

Basically, the ship complete component tries to send an order at one time and moves the delivery for that order to an earlier date if the completed order cannot send prior to the due date. As the delivery date is moved back, the business operations are adjusted to meet the new earlier due date without effecting other orders.

When the user places the order through commit system 100, he may optionally designate the order as single source. If the customer orders are directly imported, the single source will automatically occur, as customer orders are placed directly on the SKUs that are to satisfy the demand. For any order that the user designates as Single Source, the commit system 100 can be set up such that all line items on that order are checked for availability at one location within the acceptable horizon. The commit system 100 provides a response whenever an acceptable answer is found. Optionally, desired behavior would include specifying single source further up in the supply chain, not just at the location that is shipping to the customer. Also, a user may specify within a customer profile whether single source customer orders are desirable.

When promising and planning supply for customer order it is sometimes desirable for all of the supply used to meet the demand to come from one, and only one, source location (this source location represents the location from which the supply is shipped to the customer). This can be due to desired efficiencies with shipments and/or the capabilities of the customer's order management system that may only allow one receipt per order. From a customer perspective, it does not matter what location the items on the order come from, as long as they all come from one location.

Although the order header date will show the order available when all line items on that order can be met, the user may want to see the individual line items' availability dates. This will allow them to remove items that are holding up the order, if desired. Commit system 100 will provide this information. Users of commit system 100 may place an inquiry to find out what items are holding up the order or that are causing it to be unmet. When a Met response is returned, all line items' dates will be the latest item's promise date. No visibility into the line item that is causing the delivery date of the order will be provided.

If “ship complete” items can not be met in full, the customer will sometimes want to receive part of an order anyway. In these cases, the user may override the ship complete requirement if requested by the customer, step 226. Similarly, in order to avoid inventory carrying costs, customers may want to shift the manufacturing dates on available items if the need date can not be met on the entire order and the customer does not want a partial delivery.

In one embodiment, commit system 100 can recommend items to be shipped together and also to ensure that finished good inventory is not being held within the network in order to complete a ship complete order step 280. Also, ship complete functionality may be expanded to include enhanced optimization capabilities such as combining order requirements into one available quantity and increased flexibility and automation in splitting orders.

If the order ships comes from two different plants and/or times, the commit system 100 may merge in transit or ship to defined delivery window if customer requests it in 260. The Commit system 100 sets the need date correctly based on the different lead times. Transportation planning should be able to planning the “merge in transit”

There are some cases where customers are more concerned about receiving “sets” of the products that they ordered together than they are about receiving all of the line items together. The commit system 100 may then attempt to provide the desired sets of SKUs. Commit system 100 also has the ability in step 220, to assign a “set” requirement for some or all the order line items within an order. For example, a customer might want to specify a CPU, monitor and keyboard as a “set”. When an order is specified as a “set,” all items of the “set” must be received before the order will be shipped. In addition, the commit system 100 will contain the logic to override the “set” requirement if the customer requests it. In the example, the customer may decide they are willing to accept just CPU's if keyboards and/or monitors aren't available. In effect, the user may specify a portion of an order to ship complete.

In highly constrained supply chains, the requested item may not be available in the requested quantity on the requested date. This commit system may provide the ability for the user to select from a list of similar products that may have availability at the previously requested date, step 250. Alternatively, this feature could be used to sell a customer on similar items but upgraded item. Similarly, a finished good alternates feature may affect how several of the features described in the specification will behave, particularly ship complete, sets, and single source. When marking a customer order as ship complete, the user expects that the commit system 100 first checks the availability of the line items requested, and if all aren't available within an acceptable timeframe, then the commit system 100 will look at any finished goods alternates. It is expected that only the finished good alternates of items that are delaying the shipment would be checked to see if the alternate is available on time. This same logic can be applied to sets and single source.

If, when implementing finished good alternates, the user is able to specify a ranking with the finished good alternates for an item, then through the implementation of the APIs, the alternates can be checked. The user will be able to put in the request as normal, and have commit system 100 do several queries to check for alternate availability if the first response is not successful.

Preferably, sequence of items should to be considered. The customer may not want one item holding up the entire order (e.g. if customer orders a group of items, depending on which ones are available, they may take delivery on some of them even if the entire order isn't available). Thus, the user of commit system 100 should need to have visibility of this bottleneck.

In one embodiment, the user may locate an order by the associated customer name, order number, customer address, product, date, etc. in step 290. A user may review goodness of orders to understand how the actual processing of orders compares to established goals and strategies for services levels, and customer response requirements. The goodness of orders can be gauged for example, by the following measures:

1) Number or percentage of orders met vs. unmet;

2) Number or percentage of orders met for individual customers;

3) Number or percentage or orders met by region;

4) Number or percentage or orders met by channel;

5) Number or percentage or orders met by user profile;

6) Number or percentage or orders met by product or product line;

7) Number or percentage or orders met by due date; or

8) Number or percentage or orders met by priority.

Each of these measures will give a different perspective on the overall effectiveness of the order fulfillment process and serve to highlight possible weaknesses or problems with facets of the process. Sporadic drops in the percentage of met orders may indicate periodic weaknesses in supply, transportation, inventory, or resource limitation. Persistent inability to satisfy specific types or classes of orders may indicate the need to revisit overall strategies, allocation schemes, or priority measures.

The commit system 100 may resolve problems restricting the ability to meet a specific order or class or order, step 295. Through a maintain order commitment component, orders can be classified as unmet, late, or partially met for a variety of reasons. An order is typically the end product of the supply chain—the point where the end customer receives the finished goods. Any constraints or limitations within the supply chain up to that point can influence the availability of that end product.

Causes for unmet, late, or partially met orders include supply problems in which materials or intermediate goods are not available within the timeframe required. Alternatively, with resource problems, the supplier has capacity issues that may limit or constrain the personnel or other resources needed by the processes in the supply chain. Likewise, inventory problems limit the ability of available (unallocated) inventory to fulfill an order. With transportation and delivery problems, shipping and delivery schedules and availability may constrain the order. It should be appreciated that these classifications are not wholly independent, and there may be a series of problems within the supply chain that results in an order going unmet. For example, an inventory problem may be caused by the lack of an intermediate good as input to some process, and this missing input may in turn be caused by a delivery problem.

A key to resolving order problems is to be able to isolate the root causes for particular order problems. At a higher level, it is also important to determine persistent inability to meet certain orders or classes of orders and be able to peg the inability to possible changes in the overall supply chain strategies, objectives, allocation schemes, and priorities. The appropriate remedial actions obviously depend on the underlying nature of the problem affecting the order. In this way, the system 100 may isolate and resolve issues, constraints, or other problems preventing orders from being met in a timely manner to allow the order(s) in question to be met according to business objectives, customer priorities, cash flow implications, etc.

The foregoing description of the preferred embodiments of the invention has been presented for the purposes of illustration and description. It is not intended to be exhaustive or to limit the invention to the precise form disclosed. Many modifications and variations are possible in light of the above teaching. For instance, the method of the present invention may be modified as needed to incorporate new communication networks and protocols as they are develop. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed:

1. A method for committing to a new order requesting a desired item by a desired time, the method comprising the steps of:
receiving the new order;
checking the availability of said desired item by said desired time, wherein said checking step considers expected delays associated with a delivering of said new order; and
if said desired item is available by said desired time, promising delivery of said new order.

2. The method of claim 1, wherein said step of checking the availability of said desired item by said desired time considers inventory, production, manufacturing, distribution, and transportation resources needed to deliver said desired item by said desired time.

3. The method of claim 1 further comprising the steps of:
determining an alternative item if said desired item is unavailable by said desired time;
checking the availability of said alternative item by said desired time; and
if said alternative item is available by said desired time, promising delivery of said alternative item by said desired time.

4. The method of claim 3 wherein said alternative item is predetermined.

5. The method of claim 1 further comprising the steps of:
if said desired item is unavailable by said desired time, determining a cause for the unavailability;
addressing said cause for the unavailability;
rechecking the availability of said desired item by said desired time; and
if said desired item is available by said desired time promising delivery of the new order.

6. The method of claim 1 further comprising the steps of:
if said desired item is unavailable by said desired time, determining an alternative time at which said item is available; and
promising the delivery of said desired item by said alternative time.

7. The method of claim 6, comprising the steps of
forming said alternative time by offsetting said desired time by a predetermined interval; and
checking the availability of said desired item by said alternative time.

8. The method of claim 1 further comprising the steps of:
canceling a prior order;
after canceling the prior order, rechecking the availability of said desired item by said desired time; and
promising delivery of said new order if said desired item is available by said desired time.

9. The method of claim 8 further comprising the steps of:
creating a list of existing orders; and
selecting the prior order from the existing orders that are lower in priority than the new order.

10. The method of claim 1, wherein said desired item is a promotional item and said desired time is during a promotional period.

11. The method of claim 1 further comprising the steps of:
monitoring any allocation of resources needed to ensure on-time delivery of said new order; and
intermittently providing a status report on said new order

12. The method of claim 1 further comprising the steps of:
monitoring any allocations of resources needed for on-time delivery of said new order; and
modifying the allocations of resources as needed to ensure on-time delivery of said new order.

13. The method of claim 1, further comprising the steps of:
if multiple schemes exist to make said desired items available by said desired time, determine by a low-cost scheme; and
deliver said new order using said low-cost scheme.

14. The method of claim 1, wherein said desired time is a time interval and said new order requests delivery of said desired item during said time interval.

15. The method of claim 1, wherein said desired item comprises a set of multiple products.

16. The method of claim 15 wherein said promised delivery includes one or more of said products.

17. The method of claim 15, wherein said multiple products are delivered in one shipment.

18. The method of claim 1, wherein said new order further specifies a desired location and wherein said step of checking the availability of said desired item by said desired time considers delivery to said desired location.

19. The method of claim 18, wherein said desired location includes a range of sites and wherein the new order is promised to be delivered at one of these sites.

20. The method claim 1, wherein the order specifies delivery of the desired item from a single source and wherein said step of checking the availability of said desired item by said desired time limits considers delivery from only a single source.

21. The method of claim 20, wherein the new order specifies a particular single source.

22. A method for committing to a new order requesting a desired item by a desired time, the method comprising the steps of:
creating a supply chain model containing activities effecting inventory
receiving the new order;
checking said supply chain model to determine the availability of said desired item by said desired time;
if said desired item is available by said desired time, promising delivery of said new order; and
if said new order is promised, modifying said supply chain model to reflect said new order.

23. The method of claim 22, wherein said step of checking said supply chain considers inventory, production, manufacturing, distribution, and transportation resources needed to deliver said desired item by said desired time.

24. The method of claim 22 further comprising the steps of:
determining an alternative item if said desired item is unavailable by said desired time;
checking said supply chain to determine the availability of said alternative item by said desired time;
if said alternative item is available by said desired time, promising delivery of said alternative item by said desired time; and
if said alternative item is promised by said desired date, modifying said supply chain model to reflect the promised delivery of said alternative item.

25. The method of claim 24 wherein said alternative item is predetermined.

26. The method of claim 22 further comprising the steps of:
if said desired item is unavailable by said desired time, determining a cause in the supply chain model for the unavailability;
addressing said cause in the supply chain for the unavailability; and
rechecking said supply chain model to determine the availability of said desired item by said desired time.

27. The method of claim 22 further comprising the steps of:
if said desired item is unavailable by said desired time, determining an alternative time at which said item is available; and
promising the delivery of said desired item by said alternative time.

28. The method of claim 27, comprising the steps of
forming said alternative time by offsetting said desired time by a predetermined interval; and
checking supply chain model to determine the availability of said desired item by said alternative time.

29. The method of claim 22 further comprising the steps of:
canceling a prior order; and
after canceling the prior order, rechecking the supply chain model to determine the availability of said desired item by said desired time.

30. The method of claim 29 further comprising the steps of:
creating a list of existing orders in the supply chain model; and
selecting the prior order from the existing orders that are lower in priority than the new order.

31. The method of claim 22, wherein said desired item is a promotional item and said desired time is during a promotional period.

32. The method of claim 22 further comprising the steps of:
monitoring changes in the supply chain model needed to ensure on-time delivery of said new order; and
intermittently providing a report on the status of these changes in the supply chain model.

33. The method of claim 22 further comprising the steps of:
monitoring changes in the supply chain model needed for on-time delivery of said new order; and
modifying the changes in the supply chain model needed to ensure on-time delivery of said new order.

34. The method of claim 22, further comprising the steps of:
if multiple schemes exist in the supply chain model to make said desired items available by said desired time, determine by a low-cost scheme; and
deliver said new order using said low-cost scheme.

35. The method of claim 22, wherein said desired time is a time interval and said new order requests delivery of said desired item during said time interval.

36. The method of claim 22, wherein said desired item comprises a set of multiple products.

37. The method of claim 36 wherein said promised delivery includes one or more of said products.

38. The method of claim 36, wherein said multiple products are delivered in one shipment.

39. The method of claim 22, wherein said new order further specifies a desired location and wherein said step of checking the supply chain model considers delivery to said desired location.

40. The method of claim 39, wherein said desired location includes a range of sites and wherein the new order is promised to be delivered at one of these sites.

41. The method claim 22, wherein the order specifies delivery of the desired item from a single source in the supply chain and wherein said step of checking supply chain model only considers delivery from single sources.

42. The method of claim 41, wherein the new order specifies a particular single source in the supply chain model.

43. A system for committing to a new order requesting a desired item by a desired time, the system comprising:
a database containing supply chain data; and a first server having
a means for receiving said new order, and
a means for analyzing said supply chain data to determine in real-time whether said desired item may be delivered by a desired time
whereby, if said desired item is available by said desired time, said system promises delivery of said new order and modifies said supply chain data to reflect said promised new order.

44. The system of claim 43 further comprising a second server, whereby said second server having said receiving and analyzing means, and whereby said second server receives and analyzes the new order when said first server in not available.

45. The system of claim 43 further comprising a security module for limiting a user's access to the system and for limited a user's ability to modify the supply chain data.

46. The system of claim 43 further comprising one or more application protocol interfaces (APIs) that allow the system to connect to outside systems.

47. The system of claim 43 further comprising user-interface that allows a user to access and interact with the system.

48. The system of claim 47 wherein said user-interface allows the user to access and interact with the system over a distributed network.

49. The system of claim 48 wherein said distributed network is the Internet.

50. The system of claim 43 wherein said analyzing means has a limited period of operation.

51. The system of claim 50 where said analyzing means is limited by a maximum processing time.

52. The system of claim 50 wherein analyzing means is limited by a maximum number of calculations.
